(19) United States
(12) Patent Application Publication
(10) Pub. No.: US 2026/0295530 A1
(43) Pub. Date: Oct. 1, 2026

(54) DAC APPARATUS

(71) Applicant: Honda Motor Co., Ltd., Tokyo (JP)

(72) Inventors: Hiroka Shigi, Saitama (JP); Masayuki Sadakiyo, Saitama (JP); Hibiki Kimura, Saitama (JP)

(21) Appl. No.: 19/577,328

(22) Filed: Mar. 24, 2026

(30) Foreign Application Priority Data
Mar. 28, 2025 (JP) 2025-055214

(51) Int. Cl. B01D 53/96; B01D 53/34; B01D 53/62; B01D 53/82

(52) U.S. Cl. CPC B01D 53/96; B01D 53/346; B01D 53/62; B01D 53/82; B01D 2253/20; B01D 2257/504; B01D 2258/06; B01D 2259/40088

(57) ABSTRACT

A DAC apparatus to recover CO₂ in atmosphere, includes: an adsorption chamber provided with an adsorbent for adsorbing or absorbing CO₂; an atmospheric control valve to open the adsorption chamber to the atmosphere or seal the adsorption chamber; a heat exchanger to exchange heat with the adsorbent; a heat pump to transfer heat from a low-temperature heat medium for cooling the adsorbent through the heat exchanger to a high-temperature heat medium for heating the adsorbent through the heat exchanger; a heat medium control valve to control supply of the low-temperature and high-temperature heat mediums to the heat exchanger; an adsorbent temperature sensor to detect the temperature of the adsorbent; a low-temperature heat medium temperature sensor to detect the temperature of the low-temperature heat medium; and a controller to control the atmospheric control valve and the heat medium control valve to alternately perform an adsorption step and a desorption step.

### CROSS-REFERENCE TO RELATED APPLICATION

This application is based upon and claims the benefit of priority from Japanese Patent Application No. 2025-055214 filed on March 28, 2025, the content of which is incorporated herein by reference.

### BACKGROUND OF THE INVENTION

### Field of the Invention

The present invention relates to a direct air capture (DAC) apparatus that recovers carbon dioxide (CO₂) in the atmosphere.

### Description of the Related Art

For the purpose of mitigating climate changes, research and development have been conducted on DAC technology for recovering CO₂, which is a main greenhouse gas. As such a DAC technology, a DAC apparatus that recovers CO₂ in the atmosphere using an adsorbent for adsorbing or absorbing CO₂ is known. For example, in the DAC apparatus of WO 2024/013957 A1, after outside air is introduced to adsorb CO₂ in the air to the adsorbent, the adsorbent is heated by the regenerated fluid heated by a heat pump unit to desorb CO₂ from the adsorbent, and the regenerated discharge fluid containing CO₂ that has been desorbed from the adsorbent is cooled by the regenerated fluid that has been cooled by the heat pump unit to liquefy and separate CO₂ from the regenerated discharge fluid.

However, in a case where each part is cooled using the heat pump as in the DAC apparatus described in WO 2024/013957 A1, when the outside air temperature is high, it may be difficult to appropriately cool each part.

### SUMMARY OF THE INVENTION

An aspect of the present invention is a DAC apparatus configured to recover CO₂ in the atmosphere, including: an adsorption chamber provided with an adsorbent for adsorbing or absorbing CO₂; an atmospheric control valve configured to open the adsorption chamber to the atmosphere or seal the adsorption chamber from the atmosphere; a heat exchanger provided to be capable of exchanging heat with the adsorbent; a heat pump configured to transfer heat from low-temperature heat medium for cooling the adsorbent through the heat exchanger to high-temperature heat medium for heating the adsorbent through the heat exchanger; a heat medium control valve configured to control supply of the low-temperature heat medium and the high-temperature heat medium to the heat exchanger; an adsorbent temperature sensor configured to detect a temperature of the adsorbent; a low-temperature heat medium temperature sensor configured to detect a temperature of the low-temperature heat medium; and a controller configured to control the atmospheric control valve and the heat medium control valve to alternately perform an adsorption step and a desorption step, the adsorption step circulating the atmosphere into the adsorption chamber and adsorbing CO₂ in the atmosphere to the adsorbent, the desorption step heating the adsorbent and desorbing CO₂ from the adsorbent. The controller controls the heat medium control valve to switch whether or not to supply the low-temperature heat medium to the heat exchanger in the adsorption step based on the temperature of the adsorbent detected by the adsorbent temperature sensor and the temperature of the low-temperature heat medium detected by the low-temperature heat medium temperature sensor.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an example of a configuration of gas piping of a DAC apparatus according to an embodiment of the present invention;

FIG. 2 is a block diagram schematically illustrating an example of a configuration of heat medium piping of the DAC apparatus according to the embodiment of the present invention;

FIG. 3 is a block diagram schematically illustrating an example of a control configuration of the DAC apparatus according to the embodiment of the present invention;

FIG. 4 is a diagram for describing switching between passing of water and non-passing of water in accordance with an adsorbent temperature and a temperature of low-temperature water; and

FIG. 5 is a flowchart illustrating an example of processing performed by a controller shown in FIG. 3.

### DETAILED DESCRIPTION OF THE INVENTION

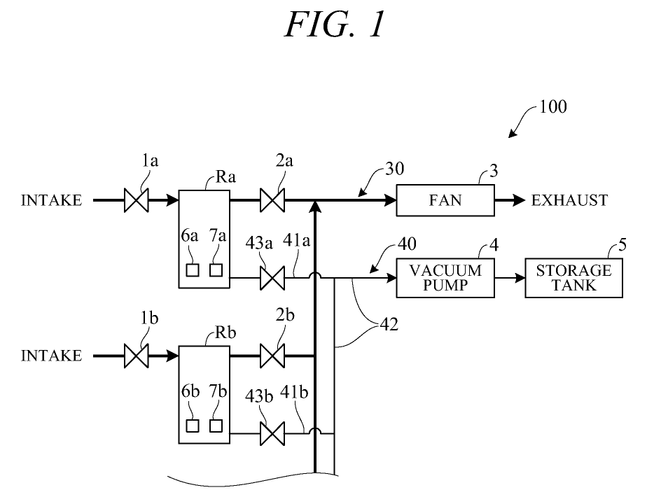

Hereinafter, embodiments of the present invention will be described with reference to FIGS. 1 to 5. FIG. 1 is a block diagram schematically illustrating an example of a configuration of gas piping of a DAC apparatus 100 according to an embodiment of the present invention. As illustrated in FIG. 1, the DAC apparatus 100 mainly includes a plurality of reactors R (Ra, Rb, and so on) in each of which an adsorbent for adsorbing or absorbing CO₂ is provided.

The reactor R includes a housing in which a sealed space (an adsorption chamber) can be formed, and an adsorbent is provided in the adsorption chamber of the reactor R. As the adsorbent, a solid material composed to adsorb CO₂ at normal temperature and normal pressure and to desorb CO₂ as the temperature rises can be used. For example, an amine-based solid absorbent in which an amine-based compound is carried on an appropriate carrier can be used. The adsorbent is constituted in an appropriate granular shape, is filled in a filter cartridge or the like having a mesh structure, for example, and is accommodated in the adsorption chamber of the reactor R.

Control valves 1 (1a, 1b, and so on) and 2 (2a, 2b, and so on), which open the reactor R to the atmosphere or seal the reactor R from the atmosphere, are provided for the reactor R. The control valves 1 and 2 may be provided on piping that connects the adsorption chamber of the reactor R with an external space, or may be provided as a part of a housing (a wall surface) of the reactor R. When the control valves 1 and 2 are opened, the adsorption chamber of the reactor R is opened to the atmosphere. When the control valves 1 and 2 are closed, the adsorption chamber of the reactor R is sealed. The control valve 1 and the control valve 2 are provided to face each other with the adsorption chamber interposed between them.

A fan 3 for circulating the atmosphere into the adsorption chamber of the reactor R is connected with the reactor R through appropriate piping (atmospheric piping) 30 and one of the control valves 1 and 2 (the control valve 2 in the illustrated example). In the illustrated example, when the control valves 1 and 2 are open and the fan 3 is driven, the atmosphere is taken into the reactor R through the control valve 1, and the atmosphere is exhausted from the reactor R through the control valve 2, the atmospheric piping 30, and the fan 3. Thus, when the atmosphere circulates into the reactor R, CO₂ in the atmosphere is adsorbed to the adsorbent in the adsorption chamber (an adsorption step). The control valves 1 and 2 and the atmospheric piping 30 are each configured to have a relatively large diameter so as to enable a large amount of atmosphere to circulate into the reactor R. A plurality of control valves 1 and a plurality of control valves 2 may be provided.

Vacuum piping 40 is further connected with the reactor R. The vacuum piping 40 connects the adsorption chamber of the reactor R with an intake port of a vacuum pump 4. More specifically, the vacuum piping 40 includes: individual piping 41 (41a, 41b, and so on), which communicates with the adsorption chamber of each reactor R; and junction piping 42, which joins the individual piping 41 to communicate with the intake port of the vacuum pump 4, and thus connects the individual piping 41 with the vacuum pump 4.

On each individual piping 41, a control valve 43 (43a, 43b, and so on), which permits or prohibits the flow of gas in the individual piping 41, that is, the flow from the reactor R to the vacuum piping 40, is provided. The control valve 43 may be made up of an on-off valve such as a ball valve, may be made up of an adjustment valve such as a butterfly valve, or may be made up of a combination of them. A storage tank 5 is connected with an exhaust port of the vacuum pump 4 through appropriate piping. The control valve 43 is closed in an adsorption step.

In the reactor R, a heat exchanger 6 (6a, 6b, and so on), which heats or cools the adsorbent, and an adsorbent temperature sensor 7 (7a, 7b, and so on), which detects a temperature Ta of the adsorbent (an adsorbent temperature), are provided. A high-temperature heat medium having a high temperature (for example, water having a high temperature (high-temperature water)) and a low-temperature heat medium having normal temperature (for example, water having a low temperature (low-temperature water)) in accordance with a desorption temperature of CO₂ are supplied to the heat exchanger 6. The heat exchanger 6 heats the adsorbent when the high-temperature water is supplied, and cools the adsorbent when the low-temperature water is supplied. In other words, the high-temperature water heats the adsorbent through the heat exchanger 6, and the low-temperature water cools the adsorbent through the heat exchanger 6.

When the control valves 1 and 2 are closed, the control valve 43 is opened, and the vacuum pump 4 is driven, the gas in the adsorption chamber of the reactor R is sucked out by the vacuum pump 4 through the vacuum piping 40. Furthermore, when the adsorbent in the adsorption chamber is heated by the heat exchanger 6, CO₂ that has been adsorbed to the adsorbent in the reactor R is desorbed. The desorption gas mainly containing the desorbed CO₂ is sucked out of the reactor R, is stored in the storage tank 5, and is recovered (a desorption step).

After the desorption step ends and before the adsorption step starts, the control valves 1 and 2 and the control valve 43 are closed, and the adsorbent in the adsorption chamber is cooled by the heat exchanger 6 (a cooling step).

In the DAC apparatus 100, the adsorption step, the desorption step, and the cooling step are sequentially performed in the plurality of reactors R by shifting the timing.

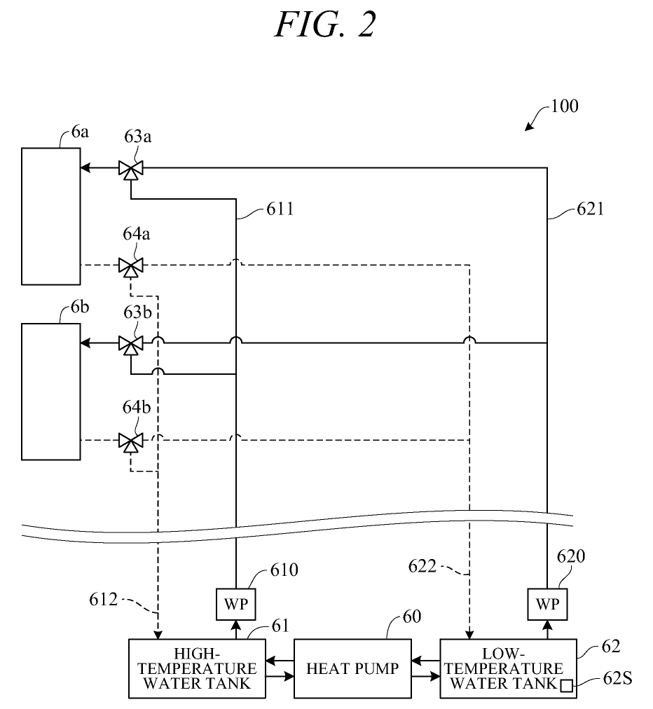

FIG. 2 is a block diagram schematically illustrating an example of a configuration of heat medium piping of the DAC apparatus 100. As illustrated in FIG. 2, in the DAC apparatus 100, a heat pump 60 for supplying high-temperature water and low-temperature water to the heat exchanger 6, which is provided in each reactor R, is provided.

The heat pump 60 includes: an evaporator (a heat exchanger) that evaporates a working fluid; a compressor that compresses the evaporated working fluid; a condenser (a heat exchanger) that condenses the compressed working fluid; and an expansion valve that expands the condensed working medium, and the heat pump 60 transfers heat of low-temperature water to high-temperature water. In the evaporator, the heat of the low-temperature water is absorbed by the working fluid, and the working fluid is evaporated (vaporized) (an evaporation step). In the compressor, a gaseous working fluid is brought into a high-temperature and high-pressure state through adiabatic compression (a compression step). In the condenser, heat of the gaseous working fluid is dissipated to the high-temperature water, and the working fluid is condensed (liquefied) (a condensation step). In the expansion valve, a liquid working fluid is brought into a low-temperature and low-pressure state through adiabatic expansion (an expansion step). The heat pump 60 circulates the working fluid between the low-temperature water and the high-temperature water, and repeats the evaporation step, the compression step, the condensation step, and the expansion step to transfer the heat of the low-temperature water to the high-temperature water.

In the heat pump 60, the rotation speed of the compressor is adjusted in such a manner that the temperature of the high-temperature water is raised to a target temperature set beforehand in accordance with a desorption temperature (for example, approximately 100 degrees Celsius) of CO₂. That is, the rotation speed of the compressor is adjusted in such a manner that the temperature of the high-temperature water coming out of the heat pump 60 becomes a target temperature in accordance with the temperature of the high-temperature water entering the heat pump 60. In the heat pump 60, the heat absorbed from the low-temperature water by the evaporator is dissipated to the high-temperature water by the condenser, and thus the temperature of the high-temperature water increases. Therefore, as the temperature rise width of the high-temperature water increases, the temperature drop width of the low-temperature water increases. As the rotation speed of the compressor increases and the load (power consumption) of the heat pump 60 increases, the temperature rise width of the high-temperature water and the temperature drop width of the low-temperature water increase.

A high-temperature water tank 61, which stores high-temperature water to be circulated to the condenser of the heat pump 60, and a low-temperature water tank 62, which stores low-temperature water to be circulated to the evaporator of the heat pump 60, are connected with the heat pump 60 through appropriate piping. In the low-temperature water tank 62, a low-temperature water temperature sensor 62S, which detects a temperature Tw of the low-temperature water (a temperature of the low-temperature water), is provided. A part of a flow passage from the heat pump 60 to the low-temperature water tank 62 is provided in close contact with the vacuum pump 4 in FIG. 1, and thus the vacuum pump 4 is cooled by the low-temperature water that has been cooled by the heat pump 60.

The high-temperature water tank 61 and the low-temperature water tank 62 are further connected with the heat exchanger 6 of each reactor R through appropriate piping, and the high-temperature water stored in the high-temperature water tank 61 and the low-temperature water stored in the low-temperature water tank 62 are circulated to the heat exchanger 6 of each reactor R through piping.

More specifically, the high-temperature water stored in the high-temperature water tank 61 flows through a flow passage 611, on which a water supply pump 610 is provided, at a flow rate corresponding to the rotation speed of the water supply pump 610, and is supplied to the heat exchanger 6 of each reactor R. After the adsorbent of each reactor R is heated, the high-temperature water discharged from the heat exchanger 6 flows through a flow passage 612, and returns to the high-temperature water tank 61.

Similarly, the low-temperature water stored in the low-temperature water tank 62 flows through a flow passage 621, on which a water supply pump 620 is provided, at a flow rate corresponding to the rotation speed of the water supply pump 620, and is supplied to the heat exchanger 6 of each reactor R. After the adsorbent of each reactor R is cooled, the low-temperature water discharged from the heat exchanger 6 flows through a flow passage 622, and returns to the low-temperature water tank 62.

A control valve (a three-way proportional control valve) 63 (63a, 63b, and so on), which switches whether to supply the high-temperature water from the flow passage 611 or to supply the low-temperature water from the flow passage 621, as a heat medium flowing through the heat exchanger 6, is provided at the inlet of the heat exchanger 6 of each reactor R. A control valve (a three-way proportional control valve) 64 (64a, 64b, and so on), which switches whether to return the heat medium that has been discharged from the heat exchanger 6 to the flow passage 612 or to return the heat medium to the flow passage 622, is provided at the outlet of the heat exchanger 6 of each reactor R. The control valves 63 and 64 are capable of adjusting the flow rate of the heat medium (the high-temperature water or the low-temperature water) flowing through the heat exchanger 6, and are capable of switching whether or not to flow the heat medium to the heat exchanger 6. The control valves 63 and 64 are respectively controlled in such a manner that the high-temperature water is circulated through the flow passages 611 and 612 to the heat exchanger 6 of the reactor R in the desorption step and the low-temperature water is circulated through the flow passages 621 and 622 to the heat exchanger 6 of the reactor R in the cooling step.

In this manner, with regard to the temperatures of the high-temperature water and the low-temperature water circulated to the heat exchanger 6 of the reactor R, into which the atmosphere circulates, so as to exchange heat with the adsorbent, the temperatures increase as the outside air temperature increases. In this case, the load of the heat pump 60, which raises the temperature of the high-temperature water to the target temperature, decreases. The temperature drop width of the low-temperature water in the heat pump 60 decreases, and the temperature Tw of the low-temperature water is continuously rising. It may be difficult to appropriately cool each unit of the DAC apparatus 100 including the adsorbent. Therefore, in the present embodiment, the DAC apparatus 100 is configured as follows in such a manner that the temperature Tw of the low-temperature water is lowered so that each unit of the apparatus can be appropriately cooled.

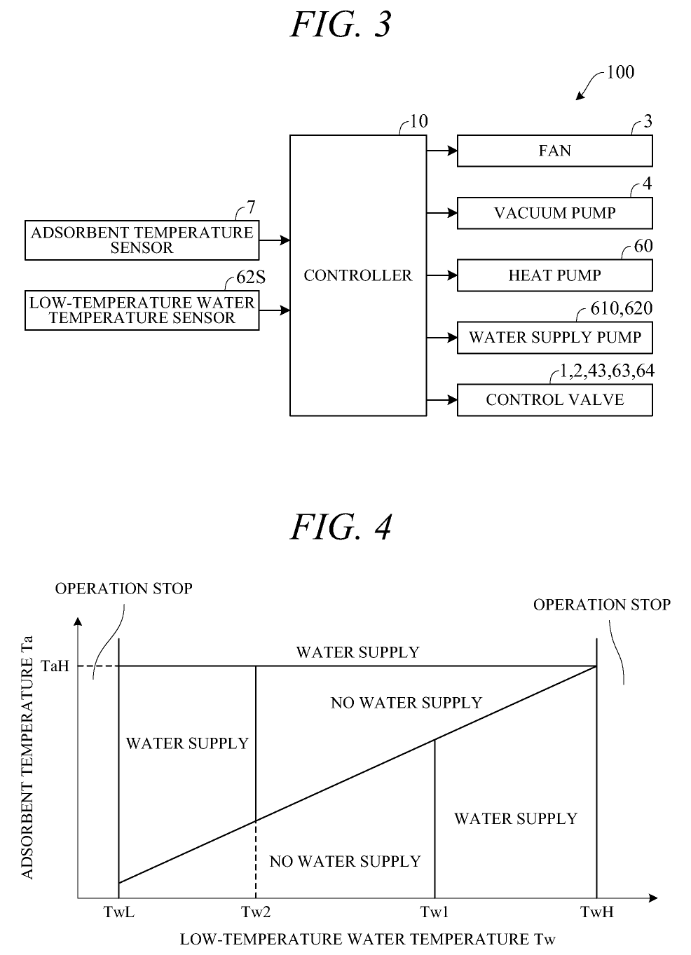

FIG. 3 is a block diagram schematically illustrating an example of a control configuration of the DAC apparatus 100. As illustrated in FIG. 3, the DAC apparatus 100 includes a controller 10, which controls each unit of the DAC apparatus 100 including the fan 3, the vacuum pump 4, the heat pump 60, the water supply pumps 610 and 620, and the control valves 1, 2, 43, 63, and 64 in FIGS. 1 and 2. The controller 10 is made up of a computer including a CPU, a ROM, a RAM, an I/O interface, and other peripheral circuits. The adsorbent temperature sensor 7 and the low-temperature water temperature sensor 62S in FIGS. 1 and 2 are connected with the controller 10, and a signal indicating a detection value of each sensor is input into the controller 10.

When the DAC apparatus 100 is activated, the controller 10 controls the control valves 1, 2, 43, 63, and 64 while driving the fan 3, the vacuum pump 4, the heat pump 60, and the water supply pumps 610 and 620. More specifically, the control valves 1, 2, 43, 63, and 64 are controlled in such a manner that the adsorption step, the desorption step, and the cooling step are sequentially performed in the plurality of reactors R by shifting the timing.

In addition, the controller 10 controls the heat medium control valves 63 and 64 to switch whether or not to supply (pass) the low-temperature water to the heat exchanger 6 in the adsorption step, based on an adsorbent temperature Ta that has been detected by the adsorbent temperature sensor 7 and the temperature Tw of the low-temperature water that has been detected by the low-temperature water temperature sensor 62S. The atmosphere is circulated into the adsorption chamber of the reactor R by the fan 3 in the adsorption step (FIG. 1). While the adsorbent temperature Ta is rising in accordance with the adsorption heat generated when CO₂ in the atmosphere is adsorbed to the adsorbent, the adsorbent temperature Ta is lowered through heat exchange with the outside air that blows through the adsorption chamber, and is maintained near the outside air temperature.

FIG. 4 is a diagram for describing switching between passing of water and non-passing of water in accordance with the adsorbent temperature Ta and the temperature Tw of the low-temperature water. As illustrated in FIG. 4, in a case where the temperature Tw of the low-temperature water is continuously rising when the outside air temperature is high, and reaches an upper limit temperature TwH, the controller 10 controls each unit to stop any operation, accompanied with heating of the adsorbent, of the DAC apparatus 100. When the temperature of the adsorbent becomes high in a state in which oxygen is present in the adsorption chamber, the adsorbent may be subject to oxidation deterioration. In order to continue the operation of the DAC apparatus 100, it is necessary to deaerate the residual atmosphere containing oxygen from the adsorption chamber of the reactor R by the vacuum pump 4 before the adsorbent is heated in the desorption step, and to cool the adsorbent with low-temperature water through the heat exchanger 6 before the atmosphere is circulated into the adsorption chamber in the adsorption step. In an abnormally high-temperature range where the temperature Tw of the low-temperature water is equal to or higher than the upper limit temperature TwH, it is possible to prevent the oxidation deterioration of the adsorbent by stopping the operation of the DAC apparatus 100. In this case, after the outside air temperature decreases, the sound operation of the DAC apparatus 100 can be resumed.

The controller 10 controls each unit to stop the operation of the DAC apparatus 100, also in a case where the temperature Tw of the low-temperature water decreases to be equal to or lower than a lower limit temperature TwL when the outside air temperature is low. During the operation of the DAC apparatus 100, it is necessary to heat the adsorbent so that the adsorbent temperature Ta is equal to or higher than the desorption temperature of CO₂ in the desorption step. However, in an abnormally low-temperature range where the temperature Tw of the low-temperature water is equal to or lower than the lower limit temperature TwL, the load and power consumption of the heat pump 60 become excessive. That is, when the outside air temperature is low in such a manner that the temperature Tw of the low-temperature water is equal to or lower than the lower limit temperature TwL, the temperature of the high-temperature water is significantly lowered in the desorption step through heat exchange with the adsorbent having the temperature that has decreased to the temperature corresponding to the outside air temperature in the adsorption step. In this case, the temperature rise width for the heat pump 60 to raise the temperature of the high-temperature water to the target temperature becomes excessive, and the load and power consumption of the heat pump 60 become excessive. In an abnormally low-temperature range where the temperature Tw of the low-temperature water is equal to or lower than the lower limit temperature TwL, it becomes possible to avoid excessive power consumption by stopping the operation of the DAC apparatus 100.

### Case of Adsorbent at High Temperature

In a case where the adsorbent temperature Ta in the adsorption step is equal to or higher than a threshold TaH, the controller 10 controls the heat medium control valves 63 and 64 to supply the low-temperature water to the heat exchanger 6 of the reactor R in the adsorption step. During the adsorption step, the adsorbent temperature Ta becomes higher than the outside air temperature due to generation of the adsorption heat. In a case where the adsorbent temperature Ta is equal to or higher than the threshold TaH, the adsorbent may be subject to the oxidation deterioration, and thus the adsorbent is cooled with low-temperature water through the heat exchanger 6. Thus, it becomes possible to prevent the oxidation deterioration of the adsorbent also when the outside air temperature is high.

### Case Where Low-Temperature Water Is Higher in Temperature Than Adsorbent

In a case where the adsorbent temperature Ta is lower than the threshold TaH and the temperature Tw of the low-temperature water is higher than the adsorbent temperature Ta, the controller 10 switches whether or not to supply the low-temperature water to the heat exchanger 6 in the adsorption step in accordance with a comparison result between the temperature Tw of the low-temperature water and a high-temperature threshold Tw1. That is, the heat medium control valves 63 and 64 are controlled in such a manner that in a case where the temperature Tw of the low-temperature water is equal to or higher than the high-temperature threshold Tw1, the low-temperature water is supplied to the heat exchanger 6 in the adsorption step, and in a case where the temperature Tw of the low-temperature water is lower than the high-temperature threshold Tw1, the low-temperature water is not supplied to the heat exchanger 6 in the adsorption step.

The high-temperature threshold Tw1 is determined beforehand from the viewpoint of cooling performance for sufficiently cooling the adsorbent of each reactor R and the vacuum pump 4. In a case where the temperature Tw of the low-temperature water is higher than the adsorbent temperature Ta, the low-temperature water is supplied to the heat exchanger 6 to exchange heat with the adsorbent, so that the heat of the low-temperature water is dissipated to the adsorbent, and the temperature Tw of the low-temperature water is lowered to ensure the cooling performance.

Therefore, in a case where the temperature Tw of the low-temperature water is equal to or higher than the high-temperature threshold Tw1 and it is necessary to lower the temperature Tw of the low-temperature water from the viewpoint of the cooling performance, the heat medium control valves 63 and 64 are controlled to supply the low-temperature water to the heat exchanger 6 in the adsorption step. On the other hand, in a case where the temperature Tw of the low-temperature water is lower than the high-temperature threshold Tw1 and there is no need to lower the temperature Tw of the low-temperature water from the viewpoint of the cooling performance, the heat medium control valves 63 and 64 are controlled not to supply the low-temperature water to the heat exchanger 6 in the adsorption step.

### Case Where Low-Temperature Water Is Lower in Temperature Than Adsorbent

In a case where the adsorbent temperature Ta is lower than the threshold TaH and the temperature Tw of the low-temperature water is lower than the adsorbent temperature Ta, the controller 10 switches whether or not to supply the low-temperature water to the heat exchanger 6 in the adsorption step in accordance with a comparison result between the temperature Tw of the low-temperature water and a low-temperature threshold Tw2. That is, the heat medium control valves 63 and 64 are controlled in such a manner that in a case where the temperature Tw of the low-temperature water is lower than the low-temperature threshold Tw2, the low-temperature water is supplied to the heat exchanger 6 in the adsorption step, and in a case where the temperature Tw of the low-temperature water is equal to or higher than the low-temperature threshold Tw2, the low-temperature water is not supplied to the heat exchanger 6 in the adsorption step.

The low-temperature threshold Tw2 is determined beforehand from the viewpoint of efficiency of the heat pump 60. That is, when the temperature Tw of the low-temperature water decreases and the temperature difference between the high-temperature water and the low-temperature water increases, the load of the heat pump 60 (the compressor), which transfers the heat of the low-temperature water to the high-temperature water, increases and the power consumption increases. In a case where the temperature Tw of the low-temperature water is lower than the adsorbent temperature Ta, the low-temperature water is supplied to the heat exchanger 6 to exchange heat with the adsorbent. The low-temperature water absorbs the heat of the adsorbent, and the temperature Tw of the low-temperature water is increased to improve the efficiency of the heat pump 60.

Therefore, in a case where the temperature Tw of the low-temperature water is lower than the low-temperature threshold Tw2 and it is necessary to raise the temperature Tw of the low-temperature water from the viewpoint of the efficiency of the heat pump 60, the heat medium control valves 63 and 64 are controlled to supply the low-temperature water to the heat exchanger 6 in the adsorption step. On the other hand, in a case where the temperature Tw of the low-temperature water is equal to or higher than the low-temperature threshold Tw2 and it is not necessary to raise the temperature Tw of the low-temperature water from the viewpoint of efficiency of the heat pump 60, the heat medium control valves 63 and 64 are controlled not to supply the low-temperature water to the heat exchanger 6 in the adsorption step.

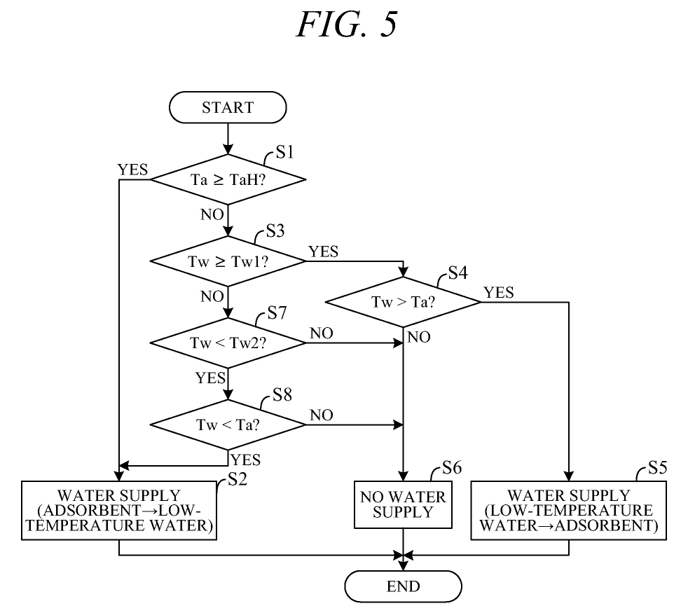

FIG. 5 is a flowchart illustrating an example of processing performed by the controller 10. The processing of FIG. 5 is started when the adsorption step is started in every reactor R, and is repeatedly performed at predetermined intervals until the adsorption step ends.

As illustrated in FIG. 5, the controller 10 first determines whether the adsorbent temperature Ta that has been detected by the adsorbent temperature sensor 7 is equal to or higher than the threshold TaH in S10 (S: processing step). In a case where an affirmative determination is made in S1, the processing proceeds to S2, and the heat medium control valves 63 and 64 are controlled to supply the low-temperature water to the heat exchanger 6. In this case, the heat of the adsorbent is dissipated to the low-temperature water, and the adsorbent temperature Ta decreases.

In a case where a negative determination is made in S1, the processing proceeds to S3 to determine whether the temperature Tw of the low-temperature water that has been detected by the low-temperature water temperature sensor 62S is equal to or higher than the high-temperature threshold Tw1. In a case where an affirmative determination is made in S3, the processing proceeds to S4, and it is determined whether the temperature Tw of the low-temperature water is higher than the adsorbent temperature Ta. In a case where an affirmative determination is made in S4, the processing proceeds to S5, and the heat medium control valves 63 and 64 are controlled to supply the low-temperature water to the heat exchanger 6. In this case, the heat of the low-temperature water is dissipated to the adsorbent, and the temperature Tw of the low-temperature water decreases. On the other hand, in a case where a negative determination is made in S4, the processing proceeds to S6, and the heat medium control valves 63 and 64 are controlled not to supply the low-temperature water to the heat exchanger 6.

In a case where a negative determination is made in S3, the processing proceeds to S7, and it is determined whether the temperature Tw of the low-temperature water is lower than the low-temperature threshold Tw2. In a case where an affirmative determination is made in S7, the processing proceeds to S8, and it is determined whether the temperature Tw of the low-temperature water is lower than the adsorbent temperature Ta. In a case where an affirmative determination is made in S8, the processing proceeds to S2, and the heat medium control valves 63 and 64 are controlled to supply the low-temperature water to the heat exchanger 6. In this case, the low-temperature water absorbs the heat of the adsorbent, and the temperature Tw of the low-temperature water rises. On the other hand, in a case where a negative determination is made in S7 or S8, the processing proceeds to S6, and the heat medium control valves 63 and 64 are controlled not to supply the low-temperature water to the heat exchanger 6.

In this manner, by switching between passing and non-passing of the low-temperature water to the heat exchanger 6 of the reactor R in the adsorption step in accordance with the adsorbent temperature Ta and the temperature Tw of the low-temperature water, it becomes possible to maintain the adsorbent temperature Ta and the temperature Tw of the low-temperature water in appropriate temperature ranges. In particular, when the temperature Tw of the low-temperature water is equal to or higher than the high-temperature threshold Tw1, the low-temperature water is caused to pass to the heat exchanger 6 so as to cool the low-temperature water through heat exchange with the adsorbent and to lower the temperature Tw of the low-temperature water, so that the cooling performance for appropriately cooling each unit of the apparatus including the adsorbent and the vacuum pump 4 can be ensured (S3 to S5). In addition, when the temperature Tw of the low-temperature water is lower than the low-temperature threshold Tw2, the low-temperature water is caused to pass to the heat exchanger 6 so as to heat the low-temperature water through heat exchange with the adsorbent and to raise the temperature Tw of the low-temperature water, so that the efficiency of the heat pump 60 can be improved (S7 to S8, S2).

According to the embodiments of the present invention, the following operation and effects are achievable.

(1) The DAC apparatus 100 includes: the reactor R in which an adsorbent for adsorbing or absorbing CO₂ is provided; the atmospheric control valves 1 and 2, which open the reactor R to the atmosphere or seal the reactor R from the atmosphere; the heat exchanger 6 provided to be capable of exchanging heat with the adsorbent; the heat pump 60, which transfers heat from the low-temperature water for cooling the adsorbent through the heat exchanger 6 to the high-temperature water for heating the adsorbent through the heat exchanger 6; the heat medium control valves 63 and 64, which control supply of the low-temperature water and the high-temperature water to the heat exchanger 6; the adsorbent temperature sensor 7, which detects the adsorbent temperature Ta; the low-temperature water temperature sensor 62S, which detects the temperature Tw of the low-temperature water; and the controller 10 configured to control the atmospheric control valves 1 and 2 and the heat medium control valves 63 and 64 to alternately perform an adsorption step and a desorption step, the adsorption step circulating the atmosphere into the reactor R, and adsorbing CO₂ in the atmosphere to the adsorbent, the desorption step heating the adsorbent, and desorbing CO₂ from the adsorbent (see FIGS. 1 to 3).

The controller 10 controls the heat medium control valves 63 and 64 to switch whether or not to supply the low-temperature water to the heat exchanger 6 in the adsorption step, based on the adsorbent temperature Ta that has been detected by the adsorbent temperature sensor 7 and the temperature Tw of the low-temperature water that has been detected by the low-temperature water temperature sensor 62S (FIGS. 4 and 5).

Thus, the adsorbent temperature Ta and the temperature Tw of the low-temperature water can be maintained in appropriate temperature ranges. In particular, when the outside air temperature is high and the temperature Tw of the low-temperature water is high, the low-temperature water is caused to pass to the heat exchanger 6, and the low-temperature water is cooled through heat exchange with the adsorbent to lower the temperature Tw of the low-temperature water, so that the cooling performance can be ensured, and each unit of the DAC apparatus 100 can be appropriately cooled. In addition, when the outside air temperature is low and the temperature Tw of the low-temperature water is low, the low-temperature water is caused to pass to the heat exchanger 6, and the low-temperature water is heated through heat exchange with the adsorbent to raise the temperature Tw of the low-temperature water, so that the efficiency of the heat pump 60 can be improved.

(2) When the adsorbent temperature Ta is equal to or higher than the threshold TaH, the controller 10 controls the heat medium control valves 63 and 64 to supply the low-temperature water to the heat exchanger 6 in the adsorption step (S1→S2 in FIGS. 4 and 5). Thus, when the outside air temperature is high and the adsorbent temperature Ta is high, the low-temperature water is caused to pass to the heat exchanger 6, and the adsorbent is cooled through heat exchange with the low-temperature water to lower the adsorbent temperature Ta, so that the oxidation deterioration of the adsorbent can be prevented.

(3) When the adsorbent temperature Ta is lower than the threshold TaH and the temperature Tw of the low-temperature water is higher than the adsorbent temperature Ta, and in a case where the temperature Tw of the low-temperature water is equal to or higher than the high-temperature threshold Tw1, the controller 10 supplies the low-temperature water to the heat exchanger 6 in the adsorption step (S1→S3→S4→S5 in FIGS. 4 and 5), and in a case where the temperature Tw of the low-temperature water is lower than the high-temperature threshold Tw1, the controller 10 controls the heat medium control valves 63 and 64 not to supply the low-temperature water to the heat exchanger 6 in the adsorption step (S1→S3→S7→S6, S1→S3→S7→S8→S6 in FIGS. 4 and 5). In this manner, in a case where the temperature Tw of the low-temperature water is equal to or higher than the high-temperature threshold Tw1, the low-temperature water is caused to pass to the heat exchanger 6, and the low-temperature water is cooled through heat exchange with the adsorbent so as to lower the temperature Tw of the low-temperature water. Thus, it becomes possible to maintain the temperature Tw of the low-temperature water at which each unit of the DAC apparatus 100 can be appropriately cooled.

When the adsorbent temperature Ta is lower than the threshold TaH and the temperature Tw of the low-temperature water is lower than the adsorbent temperature Ta, and in a case where the temperature Tw of the low-temperature water is lower than the low-temperature threshold Tw2, which is lower than the high-temperature threshold Tw1, the controller 10 supplies the low-temperature water to the heat exchanger 6 in the adsorption step (S1→S3→S7→S8→S2 in FIGS. 4 and 5), and in a case where the temperature Tw of the low-temperature water is equal to or higher than the low-temperature threshold Tw2, the controller 10 controls the heat medium control valves 63 and 64 not to supply the low-temperature water to the heat exchanger 6 in the adsorption step (S1→S3→S4→S6, S1→S3→S7→S6 in FIGS. 4 and 5). In this manner, in a case where the temperature Tw of the low-temperature water is lower than the low-temperature threshold Tw2, the low-temperature water is caused to pass to the heat exchanger 6 so as to heat the low-temperature water through heat exchange with the adsorbent and to raise the temperature Tw of the low-temperature water. Thus, it becomes possible to maintain the temperature Tw of the low-temperature water at which the heat pump 60 has superior efficiency.

(4) The DAC apparatus 100 further includes the vacuum pump 4, which is connected with the reactor R through the vacuum piping 40, and which sucks the desorption gas from the adsorbent (FIG. 1). The low-temperature water further cools the vacuum pump 4. In this case, using the low-temperature water maintained in the appropriate temperature range, it becomes possible to sufficiently cool the vacuum pump 4, which is used particularly in a high-load state among the respective units of the DAC apparatus 100. Thus, power consumption necessary for driving the vacuum pump 4 can be suppressed, and in addition, the pump efficiency of the vacuum pump 4 and CO₂ recovery efficiency can be improved.

In the above embodiment, the specific arrangements of the adsorbent temperature sensor 7 and the low-temperature water temperature sensor 62S have been described by illustrating examples in FIGS. 1 and 2. However, the adsorbent temperature detection unit that detects the temperature of the adsorbent and the low-temperature heat medium temperature detection unit that detects the temperature of the low-temperature heat medium are not limited to them. For example, a temperature sensor may be provided only in the representative reactor R to detect the adsorbent temperature Ta that represents the adsorbent temperature Ta of the respective reactors R, or an outside air temperature sensor may be provided to estimate the adsorbent temperature Ta of each reactor R from the detected outside air temperature. In addition, a temperature sensor may be provided on the heat medium piping through which the low-temperature water flows to detect the temperature Tw of the low-temperature water in each flow passage. In this case, the upper limit temperature TwH, the lower limit temperature TwL, the high-temperature threshold Tw1, and the low-temperature threshold Tw2 may be set to be different depending on every detection point of the temperature Tw of the low-temperature water.

The above embodiment can be combined as desired with one or more of the aforesaid modifications. The modifications can also be combined with one another.

According to the present invention, it becomes possible to appropriately cool each unit of the DAC apparatus.

Above, while the present invention has been described with reference to the preferred embodiments thereof, it will be understood, by those skilled in the art, that various changes and modifications may be made thereto without departing from the scope of the appended claims.

1. A DAC apparatus configured to recover CO₂ in the atmosphere, comprising:
an adsorption chamber provided with an adsorbent for adsorbing or absorbing CO₂;
an atmospheric control valve configured to open the adsorption chamber to the atmosphere or seal the adsorption chamber from the atmosphere;
a heat exchanger provided to be capable of exchanging heat with the adsorbent;
a heat pump configured to transfer heat from a low-temperature heat medium for cooling the adsorbent through the heat exchanger to a high-temperature heat medium for heating the adsorbent through the heat exchanger;
a heat medium control valve configured to control supply of the low-temperature heat medium and the high-temperature heat medium to the heat exchanger;
an adsorbent temperature sensor configured to detect a temperature of the adsorbent;
a low-temperature heat medium temperature sensor configured to detect a temperature of the low-temperature heat medium; and
a controller configured to control the atmospheric control valve and the heat medium control valve to alternately perform an adsorption step and a desorption step, the adsorption step circulating the atmosphere into the adsorption chamber and adsorbing CO₂ in the atmosphere to the adsorbent, the desorption step heating the adsorbent and desorbing CO₂ from the adsorbent, wherein
the controller controls the heat medium control valve to switch whether or not to supply the low-temperature heat medium to the heat exchanger in the adsorption step based on the temperature of the adsorbent detected by the adsorbent temperature sensor and the temperature of the low-temperature heat medium detected by the low-temperature heat medium temperature sensor.

2. The DAC apparatus according to claim 1, wherein
when the temperature of the adsorbent is equal to or higher than an upper limit temperature, the controller controls the heat medium control valve to supply the low-temperature heat medium to the heat exchanger in the adsorption step.

3. The DAC apparatus according to claim 2, wherein
when the temperature of the adsorbent is lower than the upper limit temperature and the temperature of the low-temperature heat medium is higher than the temperature of the adsorbent, the controller controls the heat medium control valve to supply the low-temperature heat medium to the heat exchanger in the adsorption step in a case where the temperature of the low-temperature heat medium is equal to or higher than a first temperature threshold and not to supply the low-temperature heat medium to the heat exchanger in the adsorption step in a case where the temperature of the low-temperature heat medium is lower than the first temperature threshold, wherein
when the temperature of the adsorbent is lower than the upper limit temperature and the temperature of the low-temperature heat medium is lower than the temperature of the adsorbent, the controller controls the heat medium control valve to supply the low-temperature heat medium to the heat exchanger in the adsorption step in a case where the temperature of the low-temperature heat medium is lower than a second temperature threshold set lower than the first temperature threshold and not to supply the low-temperature heat medium to the heat exchanger in the adsorption step in a case where the temperature of the low-temperature heat medium is equal to or higher than the second temperature threshold.

4. The DAC apparatus according to claim 1, further comprising:
a vacuum pump connected with the adsorption chamber through vacuum piping and configured to suck desorption gas from the adsorbent, wherein
the low-temperature heat medium further cools the vacuum pump.
